(19) United States
(12) Patent Application Publication
(10) Pub. No.: US 2015/0036043 A1
(43) Pub. Date: Feb. 5, 2015

(54) BIOSCICON'S CELLPHONE CAMERA - MICROSCOPE UNIVERSAL ADAPTER

(71) Applicants: Nenad Markovic, Rockville, MD (US); Olivera Markovic, Rockville, MD (US)

(72) Inventors: Nenad Markovic, Rockville, MD (US); Olivera Markovic, Rockville, MD (US)

(73) Assignee: BIOSCICON, INC., Rockville, MD (US)

(21) Appl. No.: 13/955,201

(22) Filed: Jul. 31, 2013

(51) Int. Cl. G02B 21/36; G02B 21/00; H04M 1/02

(52) U.S. Cl. CPC G02B 21/362; H04M 1/0264; G02B 21/0008
USPC 348/373

(57) ABSTRACT

This invention was made to help cytopathology laboratory personnel to use mobile phone camera interchangeably in their everyday practice, when buying more than one model-specific adapter would exceed the cost of reimbursement for such a service and is making mobile-health in clinical pathology obsolete. The interchangeability is reducing the price of using mobile health by the number of applications.

This invention is for a small, low-cost device that could simulate movements of a human examiner analyzing cytopathological specimens using the transmitted light microscope. It is about a mechanical (electromagnetic field neutral) device to enable connecting analog and digital imaging between two humans one using the microscope to generate images of microscopic preparations obtained from tissue/cell specimens for in vitro diagnostics, and the other using the remote cell phone/TV/PC monitor/display to evaluate those images and to recommend proper clinical management of subjects from whom the specimens were sampled.

This invention is about a mechanical (non-optical or electrical) device to connect an optical system (microscope) to a digital imaging telecommunication system:
a visual microscope (an optical system for specimen magnification—range 40× through 1,200×) and projection of analog images of in vitro diagnostic specimens prepared and stained on microscopic slides), with
a photosensitive digital imaging system (cell phone with camera—basic—smart phone—tablet),
to enable accurate projection of analog microscopic images onto cell phone camera sensors for conversion into digital images, for capturing, storing and managing image data files and forwarding them for share with others.

### CROSS REFERENCE TO RELATED APPLICATIONS

For the purpose of cross reference the following designations have been applied:

Information Disclosure Statements (IDS) for US Patents, designation “P”

Information Disclosure Statements (IDS) for US Patent Application Publications, designation “A”

Information Disclosure Statements (IDS) for Non-Patent Literature Documents, designation “L”

### STATEMENT FOR FEDERAL SUPPORT

This invention, from its first disclosure in 2005, to present Utility patent application, was made with no Government support, or under any contract with the US Government. In the past (2001-2004), the inventors were supported by NIH, SBIR Phase I and Phase II grants, 2001-2003).

The invention was solely made in response to growing pains of using multiple digital wired and wireless systems to capture microscopic images and to manage digital images in tasks required by telemedicine.

### STATEMENT REGARDING PRIOR DISCLOSURES

In accordance to MPEP 201.11, this utility patent application claims benefits of multiple prior applications which in chain disclose different phases of development of the invention under the current title.

These multiple prior applications are:
(1) Provisional Patent Application, Markovic O & N, BioSciCon's Smartphone—Microscope Universal Adapter (USPTO #61/742,843 from Aug. 20, 2012.[L-5]
(2) This application also claims Foreign Application PCT #12,228,653, 2009 Aug. 8.[L -25]
(3) This Application also asserts a connection with the prior art claimed in the first Provisional and the Utility Patent Application, Markovic O & N, Method and Universal Adapter System for Using Mobile Phone Camera in Telecytopathology (U.S. patent application Ser. No. 12-228,653 of Aug. 15, 2008, which is on hold (unintentionally abandoned) due to “incomplete drawings”. [L-6]
(4) This Application claims connection with the prior arts summarized in the Provisional Patent Application, Ocular Scanning Stage (OSS) for Mobile Camera Phone Intended for Telecytopathology, submitted by Drs. O &N Markovic as inventors to the USPTO office and filed under the USPTO #60/964,838 of Aug. 16, 2007. In that PPA the invention is dated in June 2007. [L-7]
(5) The inventors' have first disclosed this invention in the USPTO Invention Disclosure #585956 of Sep. 13, 2005 (OIPE Seal) under the name MarkPap® Digital Series, as MarkPap Digital. [L-7]

In comparison with the cited prior art, the current invention has (1) a new core movement mechanism, (2) a centering mechanism, and (3) the intention for use expanded application opportunities. The invention was simply developed because of the personal needs of the inventors to “replace” human hand with a low-cost device for common use as smart phone photography of microscopic images.

The invention is clearly “non-obvious” in comparison with the prior art of other people as evidenced by the patent and other database searches (attached).

### BACKGROUND OF THE INVENTION

### Technical Field

The present invention relates to a mechanical (not optical, not electrical) device to facilitate obtaining a stable conversion of analog images projected from microscopic slides (obtained from cytopatlogical specimens) into digital images captured by mobile phone cameras; thus, improving the utilization of medical image informatics and related fields, such as m-health, telemedicine, in vitro diagnostics, pathology, IT tele-photo-communication, optical microscopy and medicine at large.

This invention is for a small, low-cost device that could simulate movements of a human examiner analyzing cytopathological specimens using the transmitted light microscope. It is about a mechanical (electromagnetic field neutral) device to enable no connecting analog and digital imaging between two humans—one using the microscope to generate images of microscopic preparations obtained from tissue/cell specimens for in vitro diagnostics, and other using the remote cell phone/TV/PC monitor/display to evaluate those images and to recommend proper clinical management of subjects from whom the specimens were sampled.

### DESCRIPTION OF RELATED ART AND PRIOR ART

### Prior Art

Emerging cell phone camera technology has opened an un-precedent opportunity to use cell phones (smart phones, tablets or any other similar electronic photographic device) to capture microscope projected analog images, to convert them into digital images (still and video), store them in digital image file databases, retrieve, forward and share images or image files globally in real time or at any time. This opportunity occupied our interest for years because medical doctors should always try to deliver the best services available, and IT technology had promised high quality services for affordable cost, an achievement seen never before in medicine.
Recent advancement of M-Health has been additional incentive to our already excited research endeavors. However, there were a few barriers to pass. One of them was the inability to use cell phone cameras with microscope without costly and time consuming adjustments. We first addressed this barrier in 2003 while trying to put together a system for mass cervical cancer screening. Here is what we learned and how we finally resolved the problem. [L-12-14, 17, 19, 21]

a. To apply M-Health opportunity on patho-histo-cytological slides (specimens collected for in vitro diagnosis) one needs a cell phone camera to be attached to the microscope to provide stable, consistent and continuous connectivity while obtaining series of still or video images. Both, microscope manufacturers and cell phone camera manufacturers have produced many adapters or accessories to enable this connection. However, all of them (their number is inthousands) are closely related to the specific combination of cell phone camera with a specific type of microscope with very limited options for interchangeable use. Each and every of these combinations are well patent protected, increasing the profit opportunity, but drastically reducing the market. This is not what the users do need. As users, we needed a low-cost simple but universal adapter to connect multiple types of microscopes with continuously increasing new variants of cell phones with cameras and their ever-better alternatives. At the same time, such an adapter must be electromagnetically neutral and should not interfere with light beam carrying the images.

b. Recently, we were able to learn about two new devices claiming the ability to provide the same objective we were searching for. There are the Sky Light, a smart phone-microscope camera adapter [L-18-20] and the Universal Camera Phone/Microscope Adapter. [L-21,22] After a careful examination, we found that none can be applied at the resolution needed for pathocytological diagnosis and both had problems with finding appropriate microscopic fields and focusing the images at high magnifications. It was obvious that the developer of these products had no or insufficient help of medical personnel specialized for microscopic diagnosis of tissue/cell specimens. The problem was left to us to be resolved.

c. In our regular microscopic examination of human tissue/cells, we are using digital LCD cameras attached to photo-microscope and we are very satisfied with the results. We have tried standard cell phone cameras, but we soon realized that it is a time consuming effort with low reproducibility—human hand could not precisely repeat the position to allow for multiple still images to be captured in a series and stored. Different camera microscope adapters work but cannot be used with ever-changing new types of cell phones, smart phones, super phones or tablets coming to the market. Buying new adapters should add to the cost which changes the balance between the reimbursement for the service provided and equipment cost. This approach was unacceptable.

d. What to do? It became obvious that the service cost could be kept low only with a universal adapter which may connect any cell phone camera with any microscope. But, no such device was commercially available, nor is mentioned as the future plan of any of many manufacturers. Only two devices, recently appeared on the market, Cell Scope and Skylight, are talking of “any cell phone and any microscope,” but a closer view into it, confirmed that they are not what is advertised. We decided to create something to meet our needs—a frank universal adapter.

e. The best universal adapter is already available: it is the human hand which can hold cell phone camera in any position towards the microscope. But it cannot stay still in the desired position. Human hand is not patentable.

f. There are also robots simulating human hand movement and being controlled electronically. However, their price is very high, and cannot be calculated as the additional cost to a service used for capturing microscopic image files. And robots have already been patented.

g. Between these two extremes we decided to create a new universal adapter which commercial production should not exceed $5.00 per unit. The application options for BioSciCon's Smartphone Universal Adapter for Microscope (further SUAM)—like devices are presented in Drawings, FIG. 5

h. Another element that entered this equation was our prior knowledge of image analysis and cytopathology giving us the power to use this knowledge as control parameter against which to measure the success rate of subsequent achievements. [L-3-8,16-22, 24, 26]

i. These were the presumptions based on hard evidence that guided us along the course of this discovery. Navigating among many options, none of which was meeting our requirements, we did not wander much, but guided by a clear idea what we need, we were able to accomplish a result which, from the beginning, was not obvious neither to us nor to anybody else (versed or not versed in the art) who were going or are going to the same direction but with different approaches.

The results of our creative work are presented below.

### Related Art

In the USPTO Patent Database, the individual elements of this Invention can be found in the following classes:

Class 74. Machine Element or Mechanism.

Class 345. Computer graphic processing and selective visual display systems.

Class 348. Video & Voice Communication, In USPTO Class 348/355. As evidenced in P: 2[Namura et al].

Class 359. Optical Systems and Elements. C. D. It is a combination of a non-optical structure (adapter) with an optical element (camera lens) to improve utilization of the optical element. As evidenced in P: 3-8 (P-Bariza, Ogihara, Brock, Grinblat, Abe].

Class 382. Image Analysis. as evidenced in P: 9. [P-Bartels]

Class 396. Photography. D. Sub-combinations of picture recording apparatus such . . . camera mounting or rest, camera attachment . . . . As evidenced in P-10-22 [Pernstich, Nakamura, Uchida, Spenser, Chiang, Brock, Lee, Gartner, Sterns, Doi, Luther, Evans] and A-1,2 [Fletcher, Crocket]

Class D24 . Medical and Laboratory Equipment. The device is an (4) Laboratory equipment for (3) Diagnosis, Analysis and Treatment, used in (2) Prophylactic (Preventive) Medicine. As evidenced in A-1 [Fletcher]

Non-Patent Relevant Literature (L): Summarized in Information Disclosure Statement (IDS) under Non-patent Literature Document “L” [L-5-17, 24 25]. As evidenced in [L-18-20] (SkyLight), and [L-21, 22] (Universal Camera Phone Microscope Adapter), and [L-23] (Lens free microscope).

### BRIEF SUMMARY OF THE INVENTION

This invention is for a small, low-cost device that could simulate movements of a human examiner analyzing cytopathological specimens using the transmitted light microscope. It is about a mechanical (electromagnetic field neutral) device to enable connecting analog and digital imaging between two humans one using the microscope to generate images of microscopic preparations obtained from tissue/cell specimens for in vitro diagnostics, and the other using the remote cell phone/TV/PC monitor/display to evaluate those images and to recommend proper clinical management of subjects from whom the specimens were sampled.

The new device is a dual platform open cage-like structure connected with flexible joints, whereas lower platform has mechanism for attaching to a microscope ocular, and the upper platform has mechanism for camera sensor centering, image finding and focusing, and whereas the upper platform has flexible attachments for securing different cell phone camera models in said focused position.

SUAM is patentable under Class 74 (Machine Element of Mechanism, Subclass 117, Adjustable); Class 359 (Optical Systems and Elements), Subclass D (a combination of optical elements with non-optical structures), Class 348 (TV), Subclass 382 (Image Analysis) and Class D24 (Medical and Laboratory Equipment). Subclass 107 (equipment for diagnosis.) and 138 (viewing).

### BRIEF DESCRIPTION OF THE SEVERAL VIEWS OF THE DRAWINGS Information and elements characteristic for the structure of the new device are presented in Drawings on six pages, each with comprehensive figure labeled consecutively.

FIG. 1/6: The Virtual Core Mechanism
The mechanism enables positioning the camera sensor perpendicularly to the radius moving in all spherical directions around a central projected image plane.

Legend:
X-axis: Front/back movement in a horizontal plane
Y-axis: Right/left movement in a horizontal plane
Z-axis: Up/down movement in a vertical plane
ψ-axis: Angle 1°-3600 in a horizontal plane
θ-axis: Angle 1°-3600 in a vertical plane.
R-virtual radius moving in all directions of a dynamic sphere. Radius originates in the center on the projected image plane; camera sensor plane positioned in the tangent of this sphere.

No other microscope adapter or cell phone accessory can do the same.

FIG. 2/6 Front Upper View of the Device—Exploded View

Legend:
1. Platform S (for mobile camera)
2. Sliding plate with reticule for centering the device
3. Armature for In/Out movements of the sliding plate; a) front part
4. Platform M (for microscope attachment)
5. Over the ocular tube for moving device along Z-axis
6. Light beam trajectory
7. Light source
8. Flexible joints
9. Hardware firm platforms
10. Flexible fasteners for mobile phone camera

FIG. 3/6: Front/Upper View of the Device

Legend:
#1-#15 same as in FIG. 2/6
11. Image projection analog image above and between the platforms
12. Tube-vertical adjustment screws
13. Any mobile cell phone camera
14. Camera lens electronic circuit sensor
15. Camera display of the captured digital image

FIG. 4/6: Longitudinal Section View

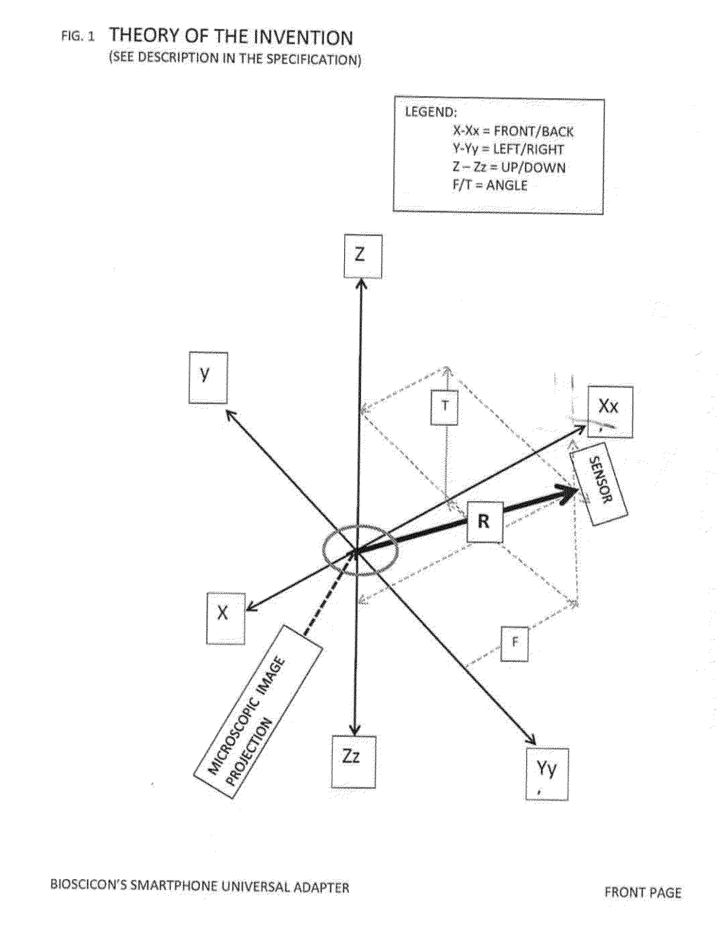

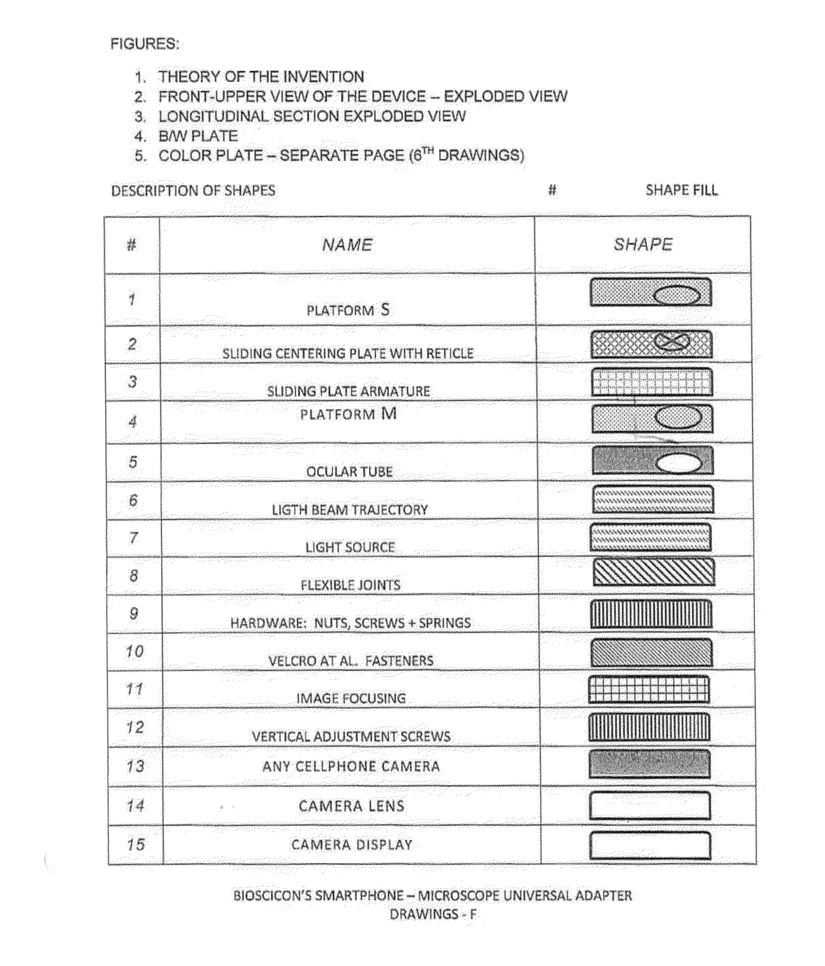

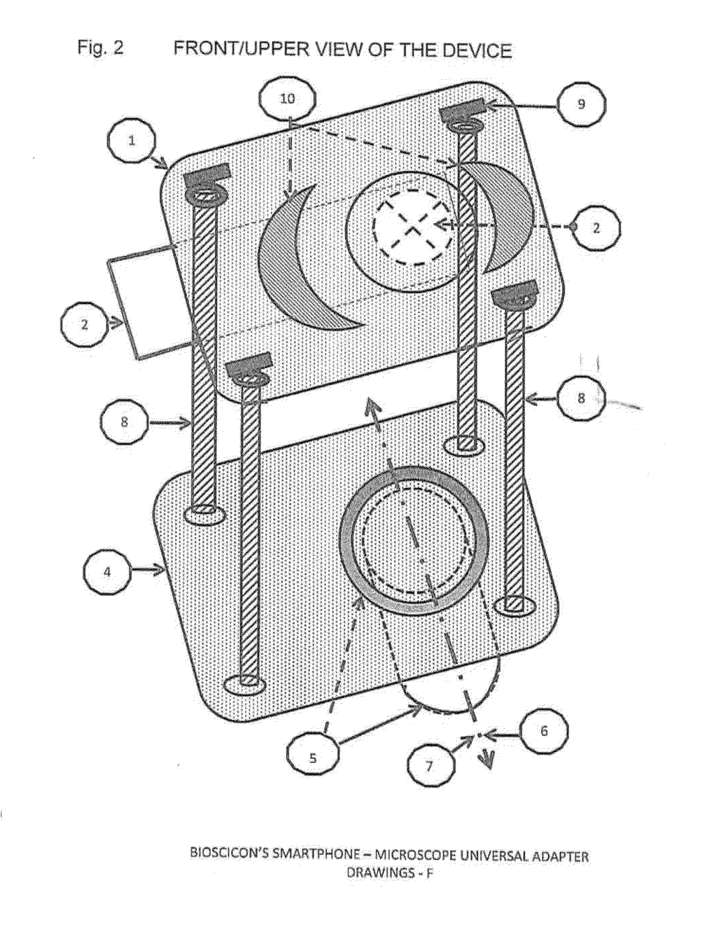

Legend:
#1 #15 Same as in 2.5 and 3/6

This is the exploded view of the section of the device cut off in half along a diagonal line (vertical plane), but upper-angled a little to present the 3-D shape view.

Again, the upper platform is (#1); the lower platform is (#4). Flexible joints hardware is #8.

Sliding Plate with cross hair filter is #2. Number #3 presents an armature guiding the plate to slide along. The tube for attachment to microscope ocular is #5, and it has openings for screws to fix it in place (#12).

A light source (#7) provides illumination and light beam trajectory (#6) passes from the ocular, through cross hair filter, opening on the upper platform and projects the image on the lens (14) of the cell phone #13. The image is then displayed on the cell phone display screen #15.

FIG. 5/6: B/W Plate

Prooving the Concept

A prototype of the new device was attached to a trinocular microscope. A cell phone camera was attached on the universal adapter. A separate digital camera was attached to the same microscope with a standard model-specific adapter. Digital images were captured simultaneously with both wired and wireless device and printed. The prototype performed satisfactory assisting examiners to obtain images which were of similar quality as those obtained by the CCD camera. (See the results presented for each image).

Description of individual images is written in the Legend below the collage.

NOTE: Color images are digitally enlarged to show pixels in B/W

FIG. 6/6: Color Plate: Universal Adapter Prototype

We included a Color Plate (market ORIGINAL) and a B/W Copy, both for your consideration. Depending of the clarity of your scan please decide which copy to use. Both have the same elements as described below.

There are four prints marked 1A-1D. They present structure of the actual prototype (1A, 1B and 1D) and its function (1C). This model is made of transparent acrylic (platforms and the sliding plate) combined with PVC (tube), nylon (plastic screws) and metal (flexible joints: screws, springs and nuts). The print (1C) presents how this prototype works, e.g., how the images were captured from a microscope, both with LCD camera and the BioSciCon's Smartphone-Microscope Universal Adapter Prototype.

NOTE: Please consider these two prints as one image for patent evaluation.

### DETAILED DESCRIPTION OF THE INVENTION

Because the core mechanism is essential, all other elements of the invention could be considered as replaceable or interchangeable. This way of understanding is giving us an opportunity to consider further development of this prototype into different commercial devices either by the way of new design patents, derived patents, or by amendments to this utility patent. Some of these options are indicated here.

This invention was made to help cytopathology laboratory personnel to use mobile phone camera interchangeably in their everyday practice, when buying more than one model specific adapter would exceed the cost of reimbursement for such a service and is making mobile-health in pathology obsolete. The interchangeability is doing quite opposite; it is reducing the price of us8ing mobile health by the number of uses this is substantial savings in pathology laboratories with hundreds of uses daily.

### Main Embodiment

### M-1

A prototype of said invention is a small, light-weight, transparent-plastic, cage-like device comprising a double platform (each size w: 3″, I:4.5″, h: ⅛′) connected with flexible joints which allow for vertical movement of 1″ (entire platform [X, Y, Y] or angles [ψ,θ) and a tube (I: 1″, d:1.5′) for connection over a microscope's ocular (rotation in circles and in depth), which is supplied with accessories for image finding and centering (removable reticule), and for positioning and fixation of cell phone cameras (velcro-based) attachments. [See Drawings 6/6 Color Plate, FIG. 1A-1D]

### Structure

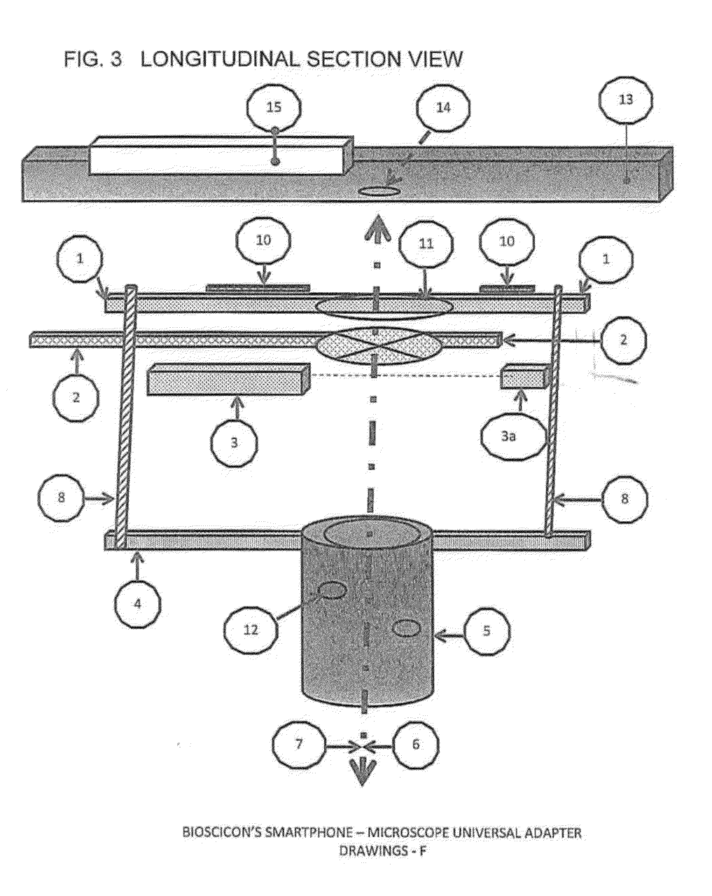

The main embodiment of this Universal Adapter is a compound structure comprising two platforms for easy attachment to the microscope and the cell phone camera, hardware to attach platforms, and accessories to facilitate the proper function of the device. [FIG. 3-6. Drawings pp. 3/6 6/6]

The total size of the device in the first embodiment is 4.5″×3.0″×3.0″

### INDIVIDUAL ELEMENTS

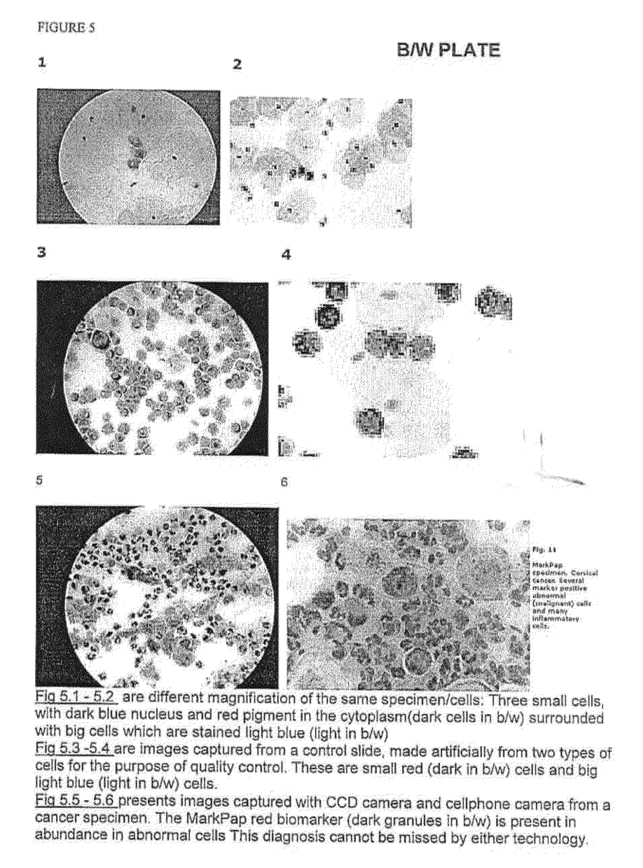

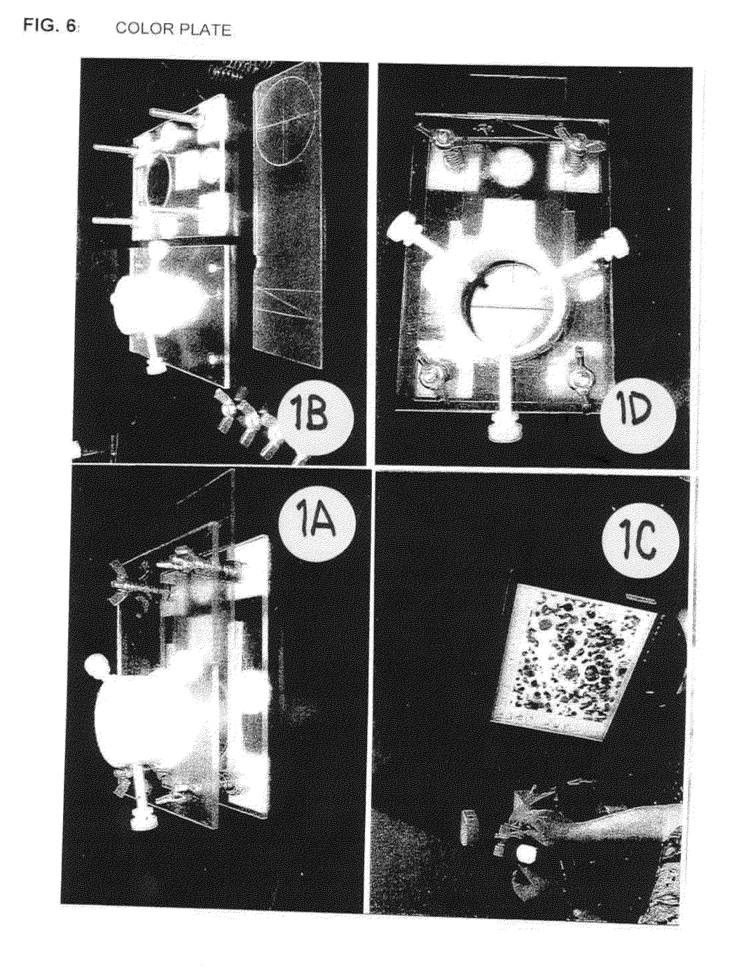

The platforms are two identical acrylic plates (4.5″×3.0″×0.125′), with 4 symmetrical perforations (D: 0.2′) for joint hardware, and one large opening for image projection (D: 1.5′). See FIGS. 3 and 4-1, 8, 9). The lower platform has a tubular attachment (length: 1.2″×interior diameter: 1.0′) which allows positioning in Z axis and ψ (horizontal angle) dimension (FIG. 1, 3, 4). The upper platform has attachments for cell phone camera in X/Y axes and θ (vertical angle) dimension. (FIG. 1, 3, 4). Flexible joints between two platforms enable positioning in θ and ψ (horizontal) position (FIGS. 3 and 4). The entire device can position any cell phone camera perpendicularly to the central radius of a virtual sphere which length depends on the shape and the size of the device (FIG. 1, 3, 4, 6)

a. S platform has a flat exterior, while its interior side, contains armature for an eyepiece-cross-hair reticule plate to slide over the viewing space and to help centering the device and the light beam (FIG. 3, 4). The S platform rests on four compression springs which length can be controlled with wing nuts. Any cell phone camera, sizes commercially available in 2013, could be placed horizontally on this platform with the camera lens looking into the center of the reticule. Once placed, the phone camera should be attached with toggle claims (included) or with Velcro or rubber collars (included) Two additional hooks are added to connect elastic bands for keeping smart phones firmly in place for repeated or continuous capturing of images. [FIG. 4/4-1, 4, 13]

b. M plat m has a microscope ocular length-adjusting tube thumb knob screws to allow fixation of the device to microscope ocular at the position in which the projected image is seen in the central beam (FIG. 3, 4, 6). M platform is also providing free viewing space between the ocular projection lens and the cell phone camera lenses. This is about 4.0″ viewing space, which is normally used to adjust human optical vision clarity between retina and the projected microscopic images. [FIG. 3, 4, 6]

### Hardware

The hardware includes Machine screws (4), nuts 8), expansion springs (4), wing nuts (4) for the platforms, plastic knurled knob screws (3) and velcro/or toggle clamps (4). (FIG. 3, 4, 6)

### Accessories

a. Upper Platform
i. Removable plate with focusing cross-line reticule (FIG. 3)
ii. Fixed rails to guide the reticule (FIG. 4, 6)
iii. Fixed stop rail to limit reticule's movements. FIG. 4)
iv. Velcro or other tying ribbon (different sizes) with small hooks for attachment to the hardware for fixing the smart phone while in operation. (FIG. 3, 4, 6)

b. Lower Platform
i. Light beam projection fitting tube (FIG. 3, 4, 6)
ii. Knurled knob screws to fix (FIG. 6)
iii. Stretchable Velcro straps (Hook & Loop) to fasten temporarily the smart phone for the adapter or appropriate clamps (hook or pneumatic type). (FIG. 3, 4, 6)

### Function

SUAM provides limited movements in 4D (X, Y, Z and D angles θor ψ). (FIG. 1-radius projections) This flexibility is needed for (1) finding the center of illumination and (2) for focusing images: microscope projection of the analog image into the viewing plane of the photo camera sensor.

Upper plate serves to position the mobile phone camera into the center of the microscopic light path trajectory (indicated by the cross-hair image in the reticule). Flexible joints are used for fine tuning of the instrument according to the quality of the digital image as seen on the cell phone analog display screen. (FIG. 4/4-1, 2, 5, 6, 14, 15)

### Instructions for Use

1. Open the carryon box and read the Instructions.
2. Confirm that all parts are present and available for installation
3. Install accessories first.
4. Install connecting joints into the lower plate with open ends on the top.
5. Install the upper plate and secure it with the wing nuts.
6. Activate the microscope by selecting the image and projecting it into ocular(s)
7. Place SUAM over one of the oculars
8. Focus the light path in the center of the cross line of the reticule.
9. Start the camera on the smart phone.
10. Looking at the smart phone camera display find the reticule's cross line and fix the image with the cross line in the center of the display. Fasten the system with easy accessible Velcro tapes.
11. Using fine movements in D-axes to adjust the analog and digital planes to the “best digital vision.”
12. Start capturing digital images and store them into the memory cards of the SUAM.
13. Retrieve and review digital images from the database. Select and store them into image data files
14. Connect with the network for sharing image files.
15. Start forwarding image data files and receiving reports.

### Application

Our Universal Adapter has been developed to solve a very specific health care problem: To enable mass cervical cancer screening based upon (1) a biomarker-improved Pap smear test, (2) specimen self-collection kit, and

(3) M-health-based web networking used to connect remote points-of-care in low resource areas with distant medical centers where quality care can be instantly applied to bridge the health opportunty discrepancy between rich and poor population in this world.

Such a noble cause cannot be accomplished without prior establishing dependable connections between those three major goals. Universal Adapter is planned to be one of these connectors between microscopic diagnosis at points-of-care and the digital medical informatic units at expert centers. A small mechanical device, but, without which, the system is not working.

Invasive cervical cancer is easy diagnosed by its symptoms: pain in lower abdomen, bloody vaginal discharge, infection and typical appearance on vaginoscopy. However, at that time the disease is advanced and almost untreatable. On the other hand, the truth is that the same diseae is preventable, if diagnosed at early stages or even at the precancerous phase and treated on time. The detection and identification of the disease in this pre-symptomatic, but treatable phase, can be done only by pathologic examination. It means a clinical diagnosis of specimens obtained from healthy women (in the procedure called cervical cancer creening), smeared on microscopic slides and examined by highly trained pathologists. There is no other way to detect tissue change in presympromatic phase.

In the midle of 20^{th} Century, Dr. George Papanicoalou was the first to made it easier. He recommended scrapping uterine cervices to obtain better specimens, special stains to make clearer images of abnormal cells, and started a School of Cytotechnology (more than 10,000 graduated) to train laboratory technologists to select women with normal specimens (above 90%) from those women whose specimens need pathologist's review. It worked. However, the number of diagnostic specimens was reduced by 9 times, but they still needed pathologists to make correct morphological diagnosis. Why? Because cytopathology is based on the subjective interpretation of a highly trained specialist examining microscopic images in the test smears and comparing with his knowledge and experience of images typical for certain clinical diagnoses. No objectivity was involved or possible at that time. At the end of 20^{th} Century Drs. Markovic further simplified this screening technique by introducing a chemical biomarker (independent of morphology, MarkPap biomarker [L-29] to identify and locate abnormal epithelial cells. This addition improved the accuracy of Pap test (false negative dropped to below 5%), but for medical diagnosis the presence of experienced pathologists at the point-of care remained to be essential. [L-24,28-32]

In the beginning of 21^{st} Century, the IT communication revolution has changed the options for health care services and introduced telemedicine as a digital medical informatics networking (including image files) and M-health as using universal cell phone cameras in the global health care system. We have found that our biomarker is excellently suited for this digital challenge.[L-8] But, how to utilize the modern technology in medical prevention practice like mass cervical cancer screening? It was necessary to built either a compound (and exepensive) cell phone camera microscope, or to create (because it was not avaialble) a new, low-cost device that can provide tools for the same service but for low, affordable cost of e.g., $5.00-$15.00 per test and less than $5.00 per product. [L-10]

This was the challenge we have tried to resolve. The solution of this problem is presented in said patent application. For those who need more prior evidence, below are a few examples.

16. The example presented on FIG. 1C shows SUAM attached to the ocular of the microcope and the digital CCD camera mounted on the photo ocular on the same tri-ocular microscope. The operatoir compares the images captured by both cameras from the same specimen in real time.

Examples of images of the microscopic fields with both mobile device using Universal Adapter and images of microscopic field obtained with digital camera from the same specimen are presented on FIG. 5/6. The specimen is a cervical smear cytological preparation with abnormal cervical cells highlighted by a MarkPap biomerker. Images captured by CCD digital microscopic camera (.jpeg format) are in quadrangular frames. Images captured with cell phone camera (AT&T, Samsung, Eternity) are those in round frames. Please see FIG. 5

It is obvious that the images taken by the digital camera and cell phone camera using the Universal Adapter are comparable and the image analysis or medical diagnosis could be performed interchangeably. Our Universal Adapter that can be used on “any microscope” and “any cellphone camera” is essential to obtain internal consistency reliability of the measures, allowing the diagnosis of abnormal condition.

### Other Embodiments

### M-2 Platform

It is anticipated that many device manufacturers will be interested to acquire license to the patent rights of said patent protected device and that they will be developing their own devices using said core mechanism with theoretical principles disclosed above.

To prevent probable late infringement, we are offering this option as the opportunity for them to develop new design patents using different shape and size of their devices in accordance with their own needs. This option is offered under conditions that those manufacturers disclose the core mechanism as licensed from us and pay a percent of royalty.

Among those secondary designs, the most attractive is the M2 platform. It is a simple replica of the M1 platform, but along with the perforations at the same place with M1, it has additional structure of expandable rails and clamps to allow fixation of different phones if necessary for prolonged work. The main structure is two double rails positioned at angle of 90° with Y-rail movable over X-rail to adjust the semi-frame (length, width) for the different sizes of phone cameras. Rails are equipped with different clamps to accommodate different thickness (height) of phone cameras.

Both platforms can be easily interchanged only the hardware should be placed in reverse. The M2 platform design will be subject either to a new Amendment or to a new Design Patent. It depends upon the manufacturer who will license this patent.

We claim:

1. A mechanical, non-optical or electrical, device to connect two image managing systems, an optical image projection and a digital photography system; wherein the improvement comprises of creation of an environment (a virtual core mechanism) for fast focusing of projected images by photo devices and for accurate conversion of analog into digital images.

2. A mechanical device as in claim 1, further comprises two platforms—upper [a] and lower [b]—connected with four flexible joints [c], and a removable plate with a cross-hair reticule [d].

3. An optical system as in claim 1, further comprises a microscope (transmitted or reflected light, upright or inverse architecture) with objective magnification of 20× or 40× or 60× or 100×, and ocular magnification of 4× or 10× or 12×, to create, magnify and project the analog image [i] of microscopic field under examination.

4. A digital photography system as in claim 1, further comprises of cell phone camera or smart phone or tablet camera, to capture analog images, to convert them into digital images [j], and to either display or forward digital images to remote receivers.

5. An environment (a virtual core mechanism) as in claim 1, further enabling movement of photo device (from claim 4) in 4D or spherical directions to position a projected and a captured image into a plane of best conversion from analog to digital image (A/D conversion).

6. A mechanical device lower platform [b] as in claim 1 or 2, further comprises four openings [e] for insertion of flexible joints [c] and a rigid tube [f] fixed perpendicularly to said platform to enable movements along the 3D or X,Y or Z axes of the light beam [g] projecting the image;

7. A mechanical device upper platform [a] as in claim 1 or 2, further comprising a flat platform with a hole symmetrical to the upper opening of the tube [f] and four openings [e] for insertion of flexible joints [c].

8. A mechanical device upper platform [a] as in claim 1, 2, 5 or 7, further comprising a fixed open frame [h] and a reticule plate with cross hair design [d] removable along the frame in and out of said device in claim 1.

9. A mechanical device set of flexible joints [c] as in claim 1, 2, 4 or 5, further enabling the upper platform [a] to move in 4D or at angle (ψ, θ) against the lower platform [b] of said device in claim 1 or 2, and to adjust for spherical and color aberrations of said image.

10. An upper platform as in claim 1 or 2, comprising further a set of flexible attachments [j] used for fixing mobile phone cameras of different models and sizes allowing the camera lens to be fixed in center of the projected light beam [h].

11. A core mechanism as in claim 1 or 5, further is not limited to the design of the embodiment in claim 11/1), but may provide the same service in different embodiments of commercial devices used for function as in claim 1 or claims 4-6.

12. A core mechanism as in claim 1 or 5, is an essential element for application of said device in claim 1, either being in embodiment described or other similar to it.
